(19) United States
(12) Patent Application Publication
(10) Pub. No.: US 2015/0019097 A1
(43) Pub. Date: Jan. 15, 2015

(54) CONTROL SYSTEM FOR VEHICLE

(71) Applicant: TOYOTA JIDOSHA KABUSHIKI KAISHA, Toyota-shi Aichi-ken (JP)

(72) Inventors: Keisuke Morisaki, Miyoshi-shi Aichi-ken (JP); Kouji Hokoi, Toyota-shi Aichi-ken (JP)

(21) Appl. No.: 14/314,694

(22) Filed: Jun. 25, 2014

(30) Foreign Application Priority Data
Jul. 11, 2013 (JP) 2013-145814

(51) Int. Cl. B60L 7/18

(52) U.S. Cl. CPC B60L 7/18
USPC 701/70

(57) ABSTRACT

A control system for a vehicle includes a rotary electric machine and an electronic control unit. The rotary electric machine is configured to generate regenerative braking force at a wheel by generating electric power with the use of power from the wheel during braking of the vehicle. The electronic control unit is configured to acquire information including a target stopping position of the vehicle and execute deceleration control for controlling a deceleration of the vehicle by controlling regenerative power generation up to the target stopping position. The electronic control unit is configured to prohibit the deceleration control when a predetermined driving mode set in advance in response to input through driver's operation is selected from among a plurality of driving modes having specific acceleration/deceleration characteristics.

### INCORPORATION BY REFERENCE

The disclosure of Japanese Patent Application No. 2013-145814 filed on Jul. 11, 2013 including the specification, drawings and abstract is incorporated herein by reference in its entirety.

### BACKGROUND OF THE INVENTION

1. Field of the Invention

The invention relates to a control system for a vehicle, which includes a rotary electric machine and an electronic control unit and, more particularly, to deceleration control for controlling a deceleration of a vehicle by controlling regenerative power generation up to a target stopping position.

2. Description of Related Art

International Application Publication No. 2012/073373 describes a system that detects a stopping position forward of a vehicle in a traveling direction with the use of a navigation system, that determines appropriate operation timing during decelerating on the basis of a computed value of the amount of regenerated energy that can be obtained up to the stopping position, and that assists efficient deceleration by informing a driver of the timing.

In a control system for a vehicle, when deceleration control for controlling the deceleration of the vehicle by controlling regenerative power generation in a rotary electric machine up to a target stopping position, actual deceleration may be milder or may be steeper than deceleration intended by a driver. Thus, there is a concern that the driver experiences a feeling of strangeness. For example, there may be a driver's intention to change the deceleration characteristics of the vehicle, for example, when the driver manually selects a driving mode, deceleration may be significantly different from the driver's intention in the case where deceleration control is executed.

### SUMMARY OF THE INVENTION

In view of the above inconvenience, the invention provides a control system for a vehicle, which is able to suppress a feeling of strangeness by achieving deceleration close to a driver's intention in the vehicle that executes deceleration control.

An aspect of the invention provides a control system for a vehicle. The control system includes a rotary electric machine and an electronic control unit. The rotary electric machine is configured to generate regenerative braking force at a wheel by generating electric power with the use of power from the wheel during braking of the vehicle. The electronic control unit is configured to acquire information including a target stopping position of the vehicle and execute deceleration control for controlling a deceleration of the vehicle by controlling regenerative power generation up to the target stopping position. The electronic control unit is configured to prohibit the deceleration control when a predetermined driving mode set in advance in response to input through driver's operation is selected from among a plurality of driving modes having specific acceleration/deceleration characteristics.

With the thus configured control system for a vehicle, in the vehicle that executes deceleration control, deceleration control is prohibited when the predetermined driving mode is selected in response to input through driver's operation, so it is possible to suppress a feeling of strangeness by achieving deceleration close to a driver's intention.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration view of a hybrid vehicle on which a control system according to a first embodiment of the invention is mounted;

FIG. 2 is a view that shows the relationship between a target stopping position and a corresponding deceleration start position on a scheduled route stored in a navigation system shown in FIG. 1;

FIG. 3 is a view that shows a state where a vehicle speed decreases with time in the case where a vehicle is caused to stop at a target stopping position in the control system shown in FIG. 1 for comparison between the case of permission of deceleration control and the case of prohibition of deceleration control;

FIG. 4 is a block diagram that shows conditions for prohibiting deceleration control in the control system shown in FIG. 1;

FIG. 5 is a flowchart that shows a method of determining whether to prohibit or permit deceleration control in the control system shown in FIG. 1;

FIG. 6 is a view that shows an alternative embodiment of a shift operating unit that is used in the control system shown in FIG. 1;

FIG. 7 is a graph that shows the correlation between a vehicle speed and an engine rotation speed, which is set in the case where a manual mode is selected with the use of the shift operating unit shown in FIG. 7;

FIG. 8 is a flowchart that shows a method of determining whether to prohibit or permit deceleration control in a control system according to a second embodiment of the invention; and

FIG. 9 is a view that shows the configuration of another vehicle to which the control systems according to the first and second embodiments of the invention are applied.

### DETAILED DESCRIPTION OF EMBODIMENTS

Hereinafter, embodiments of the invention will be described with reference to the accompanying drawings. In the following description, a vehicle on which a control system according to the invention is mounted is a hybrid vehicle including a motor generator, which is a rotary electric machine, and an engine; however, the vehicle may be a vehicle that uses a generator instead of the motor generator. The vehicle may be an electric vehicle that includes a motor generator as a rotary electric machine and that does not include an engine. In the following description of all the drawings, like reference numerals denote similar components.

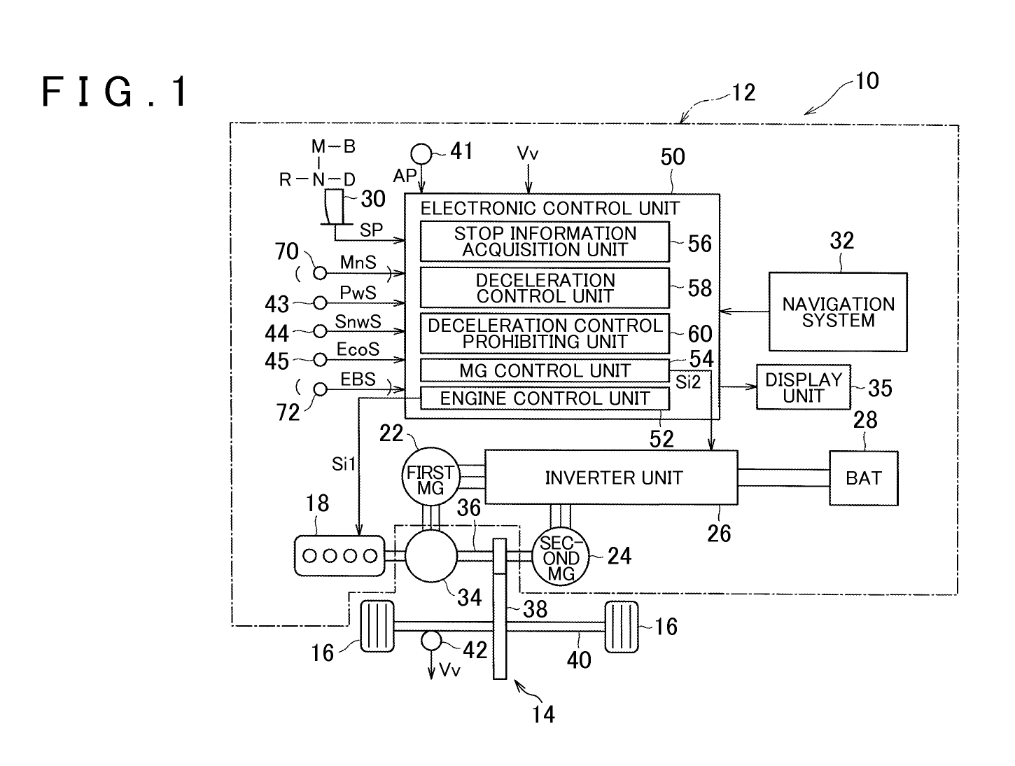

A control system for a vehicle according to a first embodiment will be described. FIG. 1 shows the schematic configuration of a hybrid vehicle 10 on which the control system 12 according to the first embodiment of the invention is mounted. The control system 12 includes an engine 18, a first motor generator 22, a second motor generator 24, an inverter unit 26, a battery 28 that serves as an electrical storage unit, a shift lever 30, a navigation system 32, a display unit 35 and an electronic control unit 50.

The hybrid vehicle 10 travels by driving wheels 16 with the use of at least one of the engine 18 and the second motor generator 24 as a driving source. In the following description, the first motor generator 22 is referred to as “first MG 22”, and the second motor generator 24 is referred to as “second MG 24”.

The engine 18 is a gasoline engine or a diesel engine. The engine 18 is controlled by a control signal Si1 from the electronic control unit 50.

The first MG 22 is a three-phase synchronous rotary electric machine, and mainly has the function of a generator that is driven by the engine 18 to generate electric power. In a power generation state of the first MG 22, at least part of torque from the engine 18 is transmitted to a rotary shaft of the first MG 22 via a power split mechanism 34 (described later). Electric power generated by the first MG 22 is supplied to the battery 28 via the inverter unit 26, and the battery 28 is charged.

The first MG 22 also has the function of an engine starter motor that starts the engine 18 via the power split mechanism 34 by being driven with the use of electric power that is supplied from the battery 28.

The second MG 24 is a three-phase synchronous rotary electric machine, and has the function of a motor that generates driving force of the vehicle by being driven with the use of electric power that is supplied from the battery 28. The second MG 24 also has the function of a generator for regenerating electric power during braking. Electric power generated by the second MG 24 is also supplied to the battery 28 via the inverter unit 26, and the battery 28 is charged. An induction rotary electric machine or another rotary electric machine may be used as each of the first MG 22 and the second MG 24.

A power transmission mechanism 14 includes the power split mechanism 34, an output shaft 36, a speed reducer 38 and axles 40. The output shaft 36 is coupled to the power split mechanism 34. The speed reducer 38 is coupled to the output shaft 36. The power split mechanism 34 is formed of a planetary gear mechanism. The planetary gear mechanism includes a sun gear, pinion gears, a carrier and a ring gear. For example, the sun gear is connected to an end portion of the hollow rotary shaft of the first MG 22. The carrier is connected to the drive shaft of the engine 18. The ring gear is connected to the output shaft 36. The output shaft 36 is connected to a rotary shaft of the second MG 24 directly or via a gear speed reducer (not shown). The output shaft 36 is connected to the axles 40 coupled to the wheels 16 via the speed reducer 38. The power split mechanism 34 distributes power from the engine 18 between a route to the output shaft 36 and a route to the first MG 22.

The inverter unit 26 is connected between the battery 28 and both the first MG 22 and the second MG 24. The inverter unit 26 includes a first inverter (not shown) and a second inverter (not shown), and is controlled by a control signal Si2 from the electronic control unit 50. The first inverter is connected between the first MG 22 and the battery 28. The second inverter is connected between the second MG 24 and the battery 28.

The first inverter drives the first MG 22 by converting direct-current voltage, supplied from the battery 28, to alternating-current voltage and supplying the alternating-current voltage to the first MG 22. The first inverter also has the function of converting alternating-current voltage, obtained through power generation when the first MG 22 generates electric power as the engine 18 is driven, to direct-current voltage and supplying the converted direct-current voltage to the battery 28.

Similarly, the second inverter drives the second MG 24 by converting direct-current voltage, supplied from the battery 28, to alternating-current voltage and supplying the alternating-current voltage to the second MG 24. The second inverter also has the function of, at the time of regenerative braking of the hybrid vehicle 10, converting alternating-current voltage, regeneratively generated by the second MG 24, to direct-current voltage and supplying the converted direct-current voltage to the battery 28. The operation of each inverter is controlled by the control signal Si2. In this case, the electronic control unit 50 (described later) controls regenerative torque of the second MG 24. Thus, the second MG 24 regeneratively generates electric power, and regenerative braking force is generated at the wheels 16. Regenerative power generation of the second MG 24 is allowed to be carried out when an accelerator pedal (described later) is released during running. A DC/DC converter may be connected between the battery 28 and both the first inverter and the second inverter. The DC/DC converter steps up the voltage of the battery 28 and then outputs the stepped-up voltage to each inverter, or steps down the voltage supplied from each inverter and then supplies the stepped-down voltage to the battery 28.

The battery 28 is formed of a nickel-metal hydride battery or a lithium ion battery, and is able to supply electric power to the first MG 22 and the second MG 24 via the corresponding inverters. A battery current sensor (not shown) is connected to the positive electrode side of the battery 28. The battery current sensor detects a charge/discharge current, and transmits the detected value to the electronic control unit 50. The electronic control unit 50 calculates a state of charge (SOC), which is the remaining level of charge of the battery 28, from an accumulated value of the charge/discharge current.

The SOC may be calculated from a detected value of a voltage sensor that detects the voltage of the battery 28 and a detected value of the battery current sensor. A capacitor may also be used as the electrical storage unit.

An accelerator position sensor 41 detects an accelerator position AP that determines an operation amount of the accelerator pedal. A signal indicating the accelerator position AP is transmitted to the electronic control unit 50.

A wheel speed sensor 42 detects a rotation speed Vv of one of the wheels 16 per unit time. A signal indicating the rotation speed Vv is transmitted to the electronic control unit 50. The electronic control unit 50 calculates a vehicle speed Vc on the basis of the rotation speed Vv. The electronic control unit 50 may calculate the vehicle speed Vc on the basis of a detected value of a second rotation sensor (not shown) that detects the rotation speed of the second MG 24.

The shift lever 30 is a shift operating unit, and is allowed to be manually changed into any one of R position, N position, D position, M position and B position. For example, the R position, the N position and the D position are arranged in the longitudinal direction or vertical direction of the vehicle, and the M position and the B position are arranged parallel to the direction along the above arrangement. The position of the shift lever 30 is detected by a position sensor (not shown). A signal indicating a detected position is transmitted to the electronic control unit 50. The M position is the initial position (home position) of the shift lever 30. Even when the shift lever 30 is operated to a position other than the M position, the shift lever 30 returns to the M position by a neutral position keeping mechanism (not shown) when the driver releases the shift lever 30.

An N range that is selected when the shift lever 30 is operated to the N position is a neutral range in which a power transmission path between a power source of the vehicle and the wheels 16 is interrupted. A D range mode that is selected when the shift lever 30 is operated to the D position is a normal forward running mode in which power for causing the vehicle to travel forward is transmitted to the wheels 16. An R range mode that is selected when the shift lever 30 is operated to the R position is a reverse driving mode in which power for causing the vehicle to travel backward is transmitted to the wheels 16. The R range mode differs in acceleration/deceleration characteristics from the D range mode. A B range mode that is selected when the shift lever 30 is operated to the B position is an increased deceleration driving mode in which the rotation speed of one or both of the first MG 22 and the second MG 24 is controlled such that engine brake is increased in the D range mode and a deceleration during decelerating increases.

The navigation system 32 assists the hybrid vehicle 10 in traveling toward a destination, and provides a scheduled route from a current location to the destination, and a required arrival time. The navigation system 32 acquires the current location from a GPS sensor (not shown). The navigation system 32 stores map information including road information, intersection information, traffic light information and temporary stop information, and identifies the current location in a map by comparing the current location with the map information. The navigation system 32 acquires destination information through user's operation, and calculates a scheduled route and required arrival time to the destination. The navigation system 32 acquires the orientation of the hybrid vehicle 10 from an orientation sensor (not shown).

When any one of an intersection, a traffic light and a temporary stop position is located near forward of the vehicle in the traveling direction on the scheduled route, the navigation system 32 sets a stopping position just before the intersection or traffic light or the temporary stop position as a target stopping position of the hybrid vehicle 10. The navigation system 32 may acquire infrastructure information including red signal information of traffic lights, and, when a traffic light forward of the vehicle indicates a red signal, may set a stopping position just before the traffic light as the target stopping position. For example, the infrastructure information may be received from an external transmission facility through radio waves. The navigation system 32 transmits a signal indicating information including the current location and the target stopping position, to the electronic control unit 50 by a CAN communication line.

The display unit 35 is a display, and is a notification unit that notifies the driver by indicating one or both of permission and prohibition of deceleration control as an execution status of deceleration control (described later). The display unit 35 may have the function of displaying information including the speed of the hybrid vehicle 10 and the position of the shift lever 30.

A power mode switch 43, a snow mode switch 44 and an economy switch 45 are provided at a position at which those switches are allowed to be operated by the driver. Signals PwS, SnwS, EcoS respectively indicating the on/off states of the power mode switch 43, snow mode switch 44 and economy switch 45 are input to the electronic control unit 50. When any one of the power mode switch 43, the snow mode switch 44 and the economy switch 45 is operated into an on state by the driver, the electronic control unit 50 sets a corresponding one of a power mode, a snow mode and an economy mode (described later).

The electronic control unit 50 does not set the power mode, the snow mode and the economy mode at the same time, and enables one of the modes, selected by only the switch operated into the on state at the latest. Each of the mode switches 43, 44, 45 is, for example, a pushbutton, and alternately switches between an on state and an off state by repeatedly pressing the pushbutton.

The electronic control unit 50 is called ECU, and includes a microcomputer including a CPU and a memory. In the example shown in the drawing, the electronic control unit 50 is illustrated as a single electronic control unit; instead, the electronic control unit 50 may be divided into a plurality of components as needed and the plurality of components may be connected to each other by a signal cable. The electronic control unit 50 includes an engine control unit 52 that controls the engine 18, an MG control unit 54 that controls the first MG 22 and the second MG 24, a stop information acquisition unit 56, a deceleration control unit 58 and a deceleration control prohibiting unit 60. The stop information acquisition unit 56, the deceleration control unit 58 and the deceleration control prohibiting unit 60 will be described later.

The engine control unit 52 generates the control signal Si1 that is output to the engine 18. The MG control unit 54 generates the control signal Si2 that is output to the inverter unit 26. When the DC/DC converter is used, the operation of the DC/DC converter is also controlled by the control signal Si2.

The electronic control unit 50 controls driving of the engine 18, the first MG 22 and the second MG 24 on the basis of a required driving power Preq based on the operation of the accelerator pedal as driver's operation. Specifically, the electronic control unit 50 calculates a required driving torque Tr* that is required in traveling on the basis of the accelerator position AP and the vehicle speed Vc by using a map or relational expression stored in a storage unit in advance. The required driving torque Tr* is a torque that is output to the output shaft 36. The electronic control unit 50 calculates the required driving power Preq from the required driving torque Tr* and the rotation speed of the output shaft 36, which is one of the rotation speed of the second MG 24 and a rotation speed that is calculated from the rotation speed of the second MG 24. The electronic control unit 50 controls driving of the engine 18, the first MG 22 and the second MG 24 such that the required driving power Preq is output to the output shaft 36.

The electronic control unit 50 calculates a power obtained by adding a required charge/discharge electric power for bringing the SOC of the battery 28 to a reference SOC, to the required driving power Preq as a target engine power Pe*, and calculates a target rotation speed Ne* and target torque Te* of the engine 18 from a predetermined engine high efficiency map. The electronic control unit 50 calculates a target rotation speed Vm1* and target torque Tr1* of the first MG 22 and a target torque Tr2* of the second MG 24 on the basis of the target rotation speed Ne* of the engine 18, a detected value of the rotation speed Vm1 of the first, MG 22, a detected value of the rotation speed Vm2 of the second MG 24 and the required driving torque Tr* by using a predetermined relational expression. The target rotation speed Ne* and target torque. Te* of the engine 18, the target rotation speed Vm1* and target torque Tr1* of the first MG 22 and the target torque Tr2* of the second MG 24 may be calculated on the basis of the accelerator position AP or on the basis of the accelerator position AP and the vehicle speed Vc by using a map stored in the storage unit (not shown).

The electronic control unit 50 outputs the calculated target rotation speed Ne* and target torque Te* of the engine 18 to the engine control unit 52. The engine control unit 52 controls driving of the engine 18 by using the control signal Si1 such that the target rotation speed Ne* and the target torque Te* are obtained. The electronic control unit 50 outputs the calculated target rotation speed Vm1* and target torque Tr1* of the first MG 22 and the calculated target torque Tr2* of the second MG 24 to the MG control unit 54. The MG control unit 54 controls driving of the first MG 22 and the second MG 24 by using the control signal Si2 such that the target rotation speed Vm1* and the target torques Tr1*, Tr2* are obtained.

In addition, the stop information acquisition unit 56 acquires information including the current location and the target stopping position from the navigation system 32. The deceleration control unit 58 executes deceleration control for controlling the deceleration of the hybrid vehicle 10 by controlling regenerative power generation of the second MG 24 up to the target stopping position.

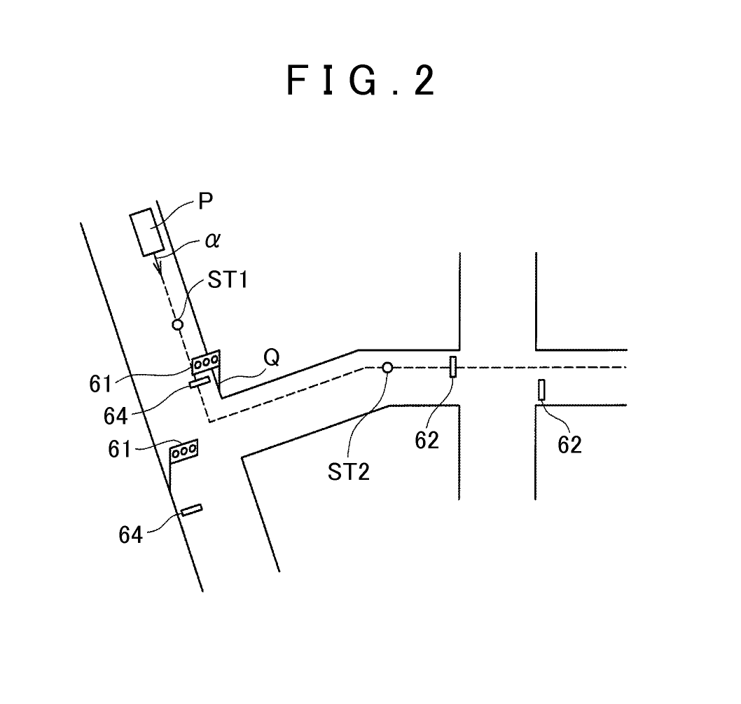

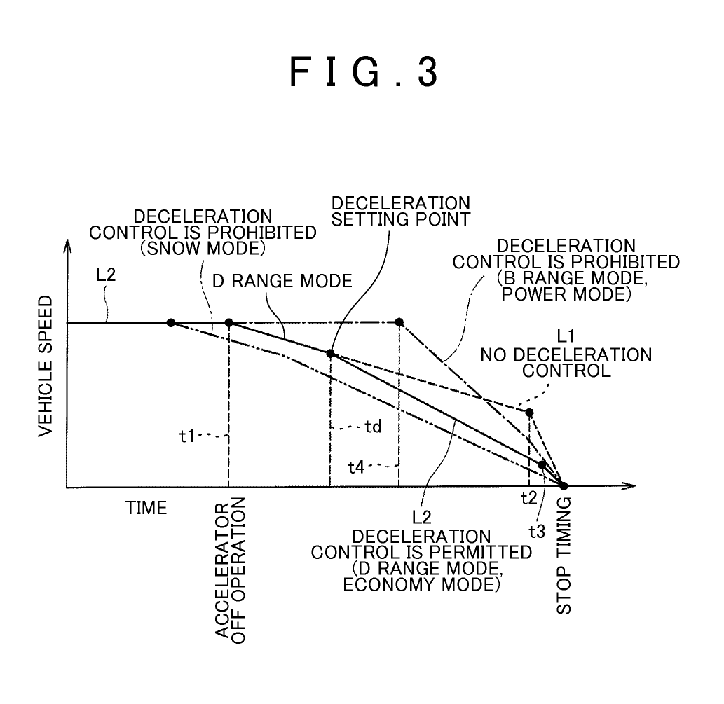

Next, deceleration control will be described with reference to FIG. 2 and FIG. 3. FIG. 2 shows the relationship between a target stopping position and a corresponding deceleration start position on a scheduled route stored in the navigation system 32. In FIG. 2, in the road information stored in the navigation system 32, the scheduled route is set as indicated by the dashed line, and traffic lights 61 and temporary stop positions 62 are set on the scheduled route. In this case, the current location of the hybrid vehicle 10 is indicated by P, and, when the hybrid vehicle 10 travels in the arrow a direction, for example, a stop line 64 just before the traffic light 61 at a Q position closest to the current location is set as the target stopping position. The navigation system 32 may have a learning function of storing a specific stopping position including a temporary stop position at which the vehicle is stopped at a certain frequency or higher, and may set the specific stopping position as the target stopping position when the specific stopping position is located forward of the current location. The navigation system 32 transmits information including the target stopping position and the current location to the stop information acquisition unit 56 of the electronic control unit 50. Hereinafter, operation that the accelerator pedal is released is termed “accelerator off operation”.

The deceleration control unit 58 obtains a deceleration start position (ST1) for increasing the amount of electric power regeneratively generated by the second MG 24, which is recoverable by the battery 28 up to the target stopping position, on the basis of the acquired target stopping position, the current location and the detected vehicle speed by using a relational expression or map set in advance. The deceleration control unit 58 calculates a deceleration setting point td that is the time at which regenerative power generation is increased from the deceleration start position and a regenerative torque corresponding to regenerative power generation that is increased from the deceleration setting point td. The deceleration control unit 58 executes control such that regenerative power generation of the second MG 24 is increased on the basis of the calculated deceleration setting point td and regenerative torque on the precondition that the driver has made accelerator off operation. In this case, the deceleration control unit 58 controls the second inverter. The deceleration setting point td and the deceleration start position are not obtained in the electronic control unit 50 but may be estimated in the navigation system 32 and then the estimated results may be transmitted to the electronic control unit 50. ST2 in FIG. 2 is the deceleration start position corresponding to the temporary stop position 62.

FIG. 3 shows a state where the vehicle speed decreases with time in the case where the hybrid vehicle 10 is caused to stop at the target stopping position in the control system 12 for comparison between permission and prohibition of deceleration control. In FIG. 3, the dashed line L1 indicates a deceleration state in the case where the D range mode is selected and deceleration control is not executed. Before the deceleration setting point td, the dashed line L1 coincides with the case where deceleration control indicated by the continuous line L2 is executed. In this case, after the driver makes accelerator off operation at time t1, the driver depresses a brake pedal at time t2 to cause the hybrid vehicle 10 to stop at stop timing corresponding to the target stopping position.

In the case where deceleration control is not executed as in the case of the dashed line L1, for example, when the brake pedal is depressed at time t2 between time td and time t3, the vehicle speed at the time of depression of the brake pedal is high, so the degree of deceleration from time t2 to the stop timing increases. The amount of electric power regeneratively generated by the second MG 24 increases as the deceleration increases. The deceleration is the degree of decrease in vehicle speed per predetermined time. However, a charging rate has an allowable upper limit. The charging rate is the rate of electric power that is supplied to the battery 28. Therefore, when the deceleration exceeds a predetermined value corresponding to the allowable upper limit, useless generated electric power that is not charged into the battery 28 occurs, so there is room for improvement in terms of improvement in fuel economy performance.

The continuous line L2 in FIG. 3 indicates the case where deceleration control is executed for the dashed line L1. In this case, the deceleration control unit 58 controls regenerative power generation through control over the second inverter such that the deceleration increases by increasing the regenerative torque of the second MG 24 as compared to that before then after the deceleration setting point td. In this case, a braking torque corresponding to engine brake that acts in the direction to decelerate the hybrid vehicle 10 increases. Therefore, the deceleration relatively early increases, with the result that the vehicle speed relatively quickly and gently decreases, so the driver is not required to strongly depress the brake pedal at time t3 even just before stopping or the speed of the hybrid vehicle 10 does not steeply decrease. Therefore, the battery 28 is able to effectively recover generated electric power, so it is possible to improve fuel economy performance.

The deceleration control unit 58 sets the deceleration setting point td such that an estimated value of the deceleration in the case where the brake pedal is depressed becomes a predetermined value smaller than a deceleration corresponding to the allowable upper limit of the charging rate of the battery 28. In execution of such deceleration control, it is assumed that the driver makes accelerator off operation in order to avoid deceleration not intended by the driver. The magnitude of such deceleration and the deceleration setting point td vary with the vehicle speed. For example, as the vehicle speed increases, the deceleration setting point td is required to be set at a closer position to the current location. For this reason, the deceleration control unit 58 calculates the deceleration setting point td on the basis of the detected vehicle speed, the current location and the target stopping position, and calculates the regenerative torque corresponding to regenerative power generation that is increased from the deceleration setting point td, thus controlling regenerative power generation of the second MG 24.

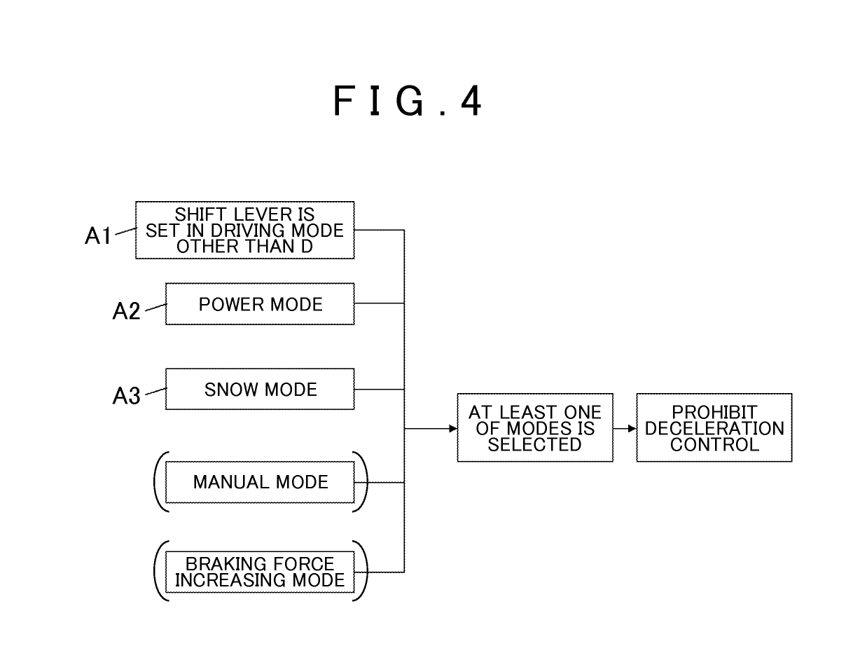

In addition, the deceleration control prohibiting unit 60 prohibits deceleration control when “predetermined driving mode” set in advance in response to unput through driver's operation is selected from among a plurality of driving modes having specific acceleration/deceleration characteristics. The plurality of driving modes having specific acceleration/deceleration characteristics include the D range mode, the B range mode, the R range mode, the power mode, the snow mode and the economy mode (described later). The “predetermined driving mode” may be a driving mode in which the deceleration characteristics of the vehicle change in response to input through driver's operation as compared to running in the D range mode that is the normal forward running mode and that does not give a higher priority too fuel economy. FIG. 4 shows conditions for prohibiting deceleration control. As shown in FIG. 4, the deceleration control prohibiting unit 60 prohibits deceleration control in the case where at least one driving mode is selected from among the following A1 mode to A3 mode as the predetermined driving mode. A1 mode to A3 mode are driving modes in which the deceleration characteristics of the vehicle change in response to input through driver's operation as compared to running in the D range mode and that do not give a higher priority to fuel economy.

The A1 mode is a driving mode that is selected when the shift lever 30 is operated to a position other the D position corresponding to the D range mode. The A1 mode includes the R range mode that is determined when operated to the R position shown in FIG. 1 or the B range mode that is determined when operated to the B position shown in FIG. 1. The A2 mode is the power mode that is selected when the power mode switch 43 is operated into the on state. The A3 mode is the snow mode that is selected when the snow mode switch 44 is operated into the on state.

Here, the power mode that is the A2 mode is a mode in which an acceleration and a deceleration are higher at the same vehicle speed than those “during normal forward running”. The time “during normal forward running” is the time during running in the D range mode and during running in which none of the power mode, the snow mode and the economy mode is set. When the power mode is set, the electronic control unit 50 is able to increase the engine torque by increasing the engine rotation speed or increasing the reference SOC such that the engine 18 is more frequently driven. The reference SOC is a reference value for engine start. The electronic control unit 50 may be configured to drive the engine 18 but not to drive the second MG 24 when the power mode is set.

The snow mode that is the A3 mode is a mode in which snow road running performance is higher than that “during normal forward running”. For example, when the snow mode is set, the electronic control unit 50 controls the engine 18, the first MG 22 and the second MG 24 such that an acceleration for operation of the accelerator pedal at the time of start traveling is reduced as compared to that during normal forward running and during running in the economy mode (described later) and a deceleration at the time of accelerator off operation during decelerating is reduced as compared to that during normal forward running and during running in the economy mode.

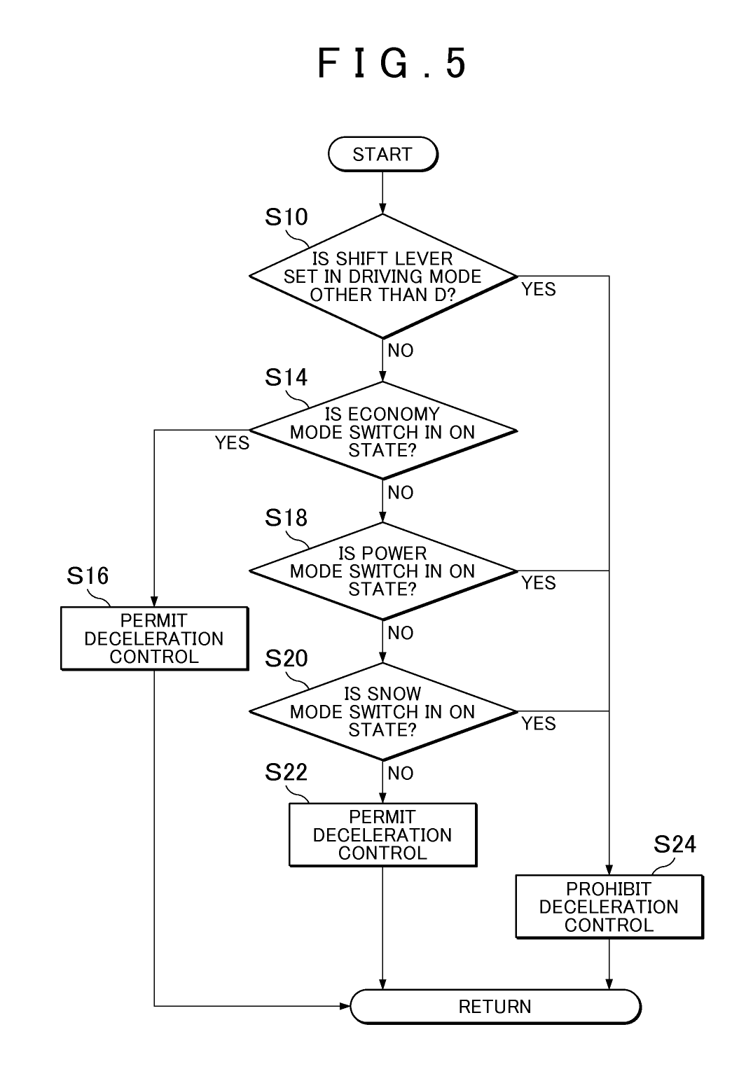

On the other hand, when the economy mode is selected when the economy switch 45 is operated into the on state, deceleration control is permitted on the condition that a driving mode other than the D range mode is not selected by the shift lever 30, as will be described with reference to FIG. 5 later. The economy mode is a fuel economy priority mode in which fuel economy performance is higher than that in the case of normal forward running. For example, when the economy mode is set, the electronic control unit 50 reduces the acceleration and deceleration of the hybrid vehicle 10 at the same vehicle speed as compared to those during normal forward running. When the economy mode is set, the electronic control unit 50 is able to decrease the reference SOC such that the frequency at which the engine 18 is driven is decreased.

On the other hand, even when the economy switch 45 is operated into the on state but when a driving mode other than the D range mode is selected by the shift lever 30, the electronic control unit 50 gives a higher priority to selection of the driving mode and prohibits deceleration control. The reason why deceleration control is prohibited in this case is because it is determined that a driver's intention to change the deceleration characteristics is further apparent through operation of the shift lever 30.

FIG. 5 is a flowchart that shows a method of determining whether to prohibit or permit deceleration control. The flowchart shown in FIG. 5 is executed by executing a program stored in the storage unit of the electronic control unit 50. Initially, in step S10 (hereinafter, step S is simply referred to as S), it is determined whether the B range mode or the R range mode, which is the driving mode other than the D range mode, is selected through operation of the shift lever 30. When the B range mode or the R range mode is selected in S10, deceleration control is prohibited in S24.

In this case, in the B range mode indicated by the alternate long and short dashed line in FIG. 3, a deceleration in the case of accelerator off operation is larger than that in the case of deceleration control, so it is possible to reduce a deceleration time, and it is possible to carry out active deceleration operation.

On the other hand, when neither the B range mode nor the R range mode is selected in S10, it is determined in S14 whether the economy switch 45 is in the on state. When the economy switch 45 is in the on state, deceleration control is permitted in S16. Deceleration operation in this case is similar to that in the case of the D range mode, indicated by the continuous line in FIG. 3.

When the economy switch 45 is in the off state in S14, it is determined in S18 whether the power mode switch 43 is in the on state. When the power mode switch 43 is in the on state, deceleration control is prohibited in S24. Deceleration operation in this case is similar to that in the case of the B range mode, indicated by the alternate long and short dashed line in FIG. 3.

When the power mode switch 43 is in the off state in S18, it is determined in S20 whether the snow mode switch 44 is in the on state. When the snow mode switch 44 is in the on state, deceleration control is prohibited in S24. In this case, in the snow mode indicated by the alternate long and two-short dashed line in FIG. 3, a deceleration in the case of accelerator off operation is smaller than that in the case of deceleration control. In this case, a deceleration time extends; however, deceleration becomes mild, so it is possible to prevent unstable vehicle behavior due to an increase in deceleration, with the result that it is advantageous in snow road running.

When the snow mode switch 44 is in the off state in S20 of FIG. 5, deceleration control is permitted (S22). For example, when the D range mode is selected by the shift lever 30 and both the power mode switch 43 and the snow mode switch 44 are in the off state, deceleration control is executed as in the case of the continuous line L2 shown in FIG. 3.

By executing deceleration control in this way, it is possible to improve fuel economy performance. In addition, deceleration control is prohibited in the case where the predetermined driving mode is selected in response to input through driver's operation. Therefore, it is possible to suppress a feeling of strangeness by achieving deceleration close to a driver's intention. Particularly, deceleration control is prohibited in the case where the driving mode, in which the deceleration characteristics of the vehicle change in response to input through driver's operation and that does not give a higher priority to fuel economy, is selected as the predetermined driving mode. Therefore, it is possible to further suppress a feeling of strangeness by achieving deceleration further close to a driver's intention.

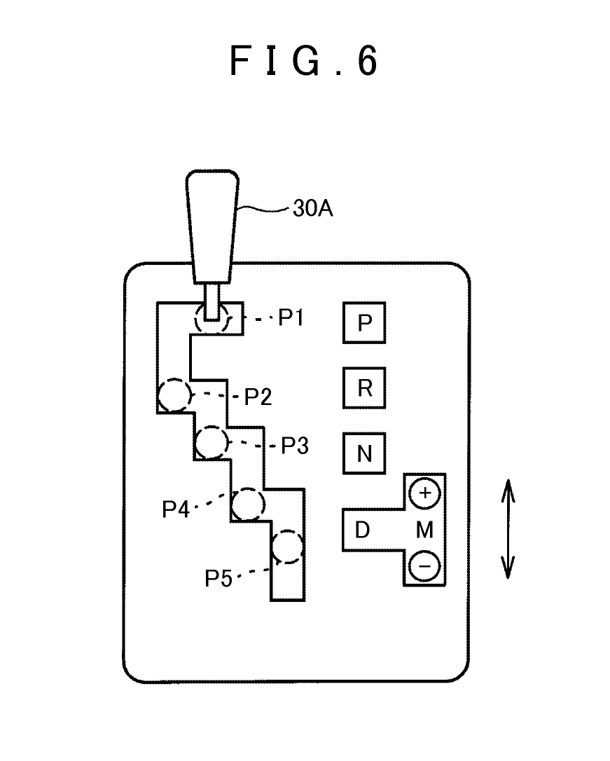

FIG. 6 shows a shift lever 30A that is an alternative embodiment of the shift operating unit that is used in the control system 12 shown in FIG. 1. The shift lever 30A is configured to be able to select a manual shift mode. Specifically, the shift lever 30A is allowed to be operated in a crank shape, and is allowed to be operated to P1, P2, P3, P4, P5 corresponding to P position, R position, N position, D position and M position. The manual mode is selected when the shift lever 30A is operated to the M position. In this case, a manual mode switch 70 (FIG. 1) (not shown in FIG. 6) is turned on in the case where the shift lever 30A is operated to P5, and a signal MnS indicating the on state is transmitted to the electronic control unit 50. The electronic control unit 50 sets the manual shift mode in response to the on signal MnS.

In the manual shift mode, the shift lever 30A is allowed to be operated in the arrow direction in FIG. 6, which is the longitudinal direction of the vehicle, the shift lever 30A is changed to a high-speed-side speed position when the shift lever 30A is operated to a forward (+) side, and the shift lever 30A is changed to a low-speed-side speed position when the shift lever 30A is operated to a rearward (−) side. After the shift lever 30A is operated to the (+) side or the (−) side, the shift lever 30A is configured to return to the M position that is the neutral position when the driver releases the shift lever 30A. Therefore, when the shift lever 30A is operated to the (+) side multiple times, the speed position changes in a stepwise manner.

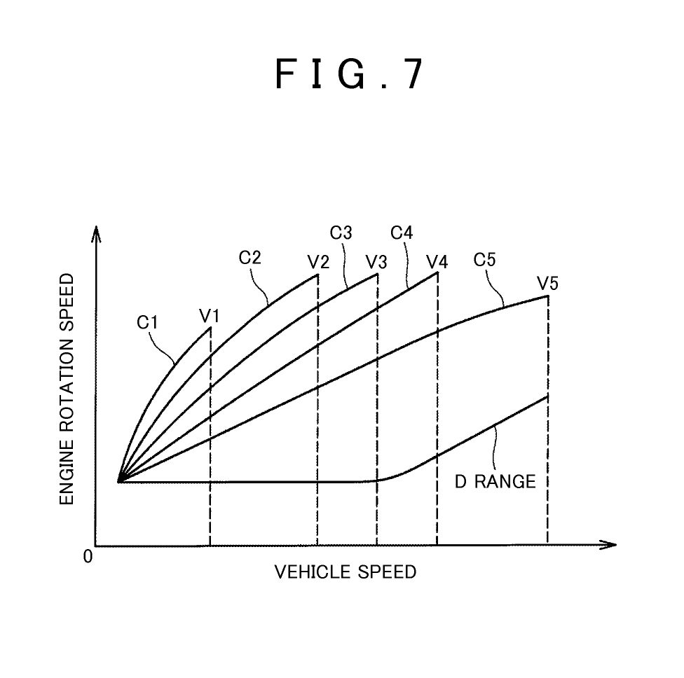

The manual shift mode is a mode in which the relationship between the operating state of the engine 18 or the second MG 24 and the vehicle speed is allowed to be changed in multiple stages. For example, the electronic control unit 50 sets a lower limit engine rotation speed on the basis of the vehicle speed when the manual shift mode is set. For example, in the example shown in FIG. 7, a plurality of speed positions C1, C2, . . . , C5 are set such that the relationship between the vehicle speed and the engine rotation speed is allowed to be changed in multiple stages. The speed position shifts to a higher speed side in order of C1, C2, . . . , C5. Among C1, C2, . . . , C5, C5 is the highest speed position of which the highest vehicle speed V5 is the highest among the highest vehicle speeds V1, V2, . . . , V5. The electronic control unit 50 stores data of a map expressing the relationship of FIG. 7, calculates the lower limit engine rotation speed on the basis of the speed position selected by the shift lever 30A and the detected vehicle speed, and controls the first MG 22 such that the rotation speed of the engine 18 becomes higher than or equal to the calculated rotation speed with the use of the power split mechanism 34.

In FIG. 7, the engine rotation speed decreases as the speed position shifts to a higher speed side in the case of the same vehicle speed, so a similar effect to that of the case where a mode for giving a higher priority to fuel economy is selected is substantially obtained.

The manual shift mode is not limited to such an example. In the manual shift mode, the relationship between the vehicle speed and the torque of the second MG 24 may be allowed to be set in multiple stages. For example, the multiple stages may be set such that the driving torque or regenerative torque of the second MG 24 is reduced as the set speed position shifts to a higher speed side in the case of the same vehicle speed. In this case, an accelerating feel or decelerating feel of the driver increases in the case where a lower-speed-side speed position is selected; whereas the accelerating feel or the decelerating feel reduces in the case where a higher-speed-side speed position is selected.

A paddle shift lever provided integrally at each of right and left sides of a steering wheel may be used as the shift lever having the manual shift mode. In this case, the right and left paddle shift levers may be configured such that the speed position is changed to a lower-speed side when the left paddle shift lever is pressed toward a near side and the sped position is changed to a higher-speed side when the right paddle shift lever is pressed toward the near side. The electronic control unit 50 enables operation of the paddle shift levers through operation of the shift lever 30A to the M position.

The control system 12 includes an engine brake switch 72 as shown in FIG. 1, and may be configured such that, when the engine brake switch 72 is operated into an on state by the driver, a signal EBS indicating the on state is transmitted to the electronic control unit 50. In this case, a braking force increasing mode for increasing engine brake during decelerating is selected. The control system 12 sets the braking force increasing mode when the engine brake switch 72 is operated into the on state. The characteristics of the braking force increasing mode are similar to the characteristics in the case where the B range mode is selected by the shift lever 30 shown in FIG. 1. When the braking force increasing mode is selected, a braking torque corresponding to engine brake may be increased by increasing the regenerative torque of the second MG 24 without operating the engine 18. This is also similar to the above-described B range mode.

As shown in FIG. 4, the deceleration control prohibiting unit 60 may be configured to prohibit deceleration control when one or both of the above manual mode and the braking force increasing mode are selected. In this case, it is determined that a driver's intention to change the deceleration characteristics is high, and deceleration close to the intention is achieved. In this case, as shown in FIG. 4, the deceleration control prohibiting unit 60 may be configured to prohibit deceleration control when at least one of the mode other than the D range mode, selected through operation of the shift lever 30, the power mode, the snow mode, the manual mode and the braking force increasing mode is selected. In this case, the deceleration control prohibiting unit 60 may be configured to prohibit deceleration control in the case where the speed position (for example, C1, C2, C3, C4 shown in FIG. 7) other than the highest speed position (for example, C5 in FIG. 7) of the manual mode is selected. In this case, the deceleration control unit 58 may be configured to permit deceleration control in the case where the highest speed position is selected in the manual mode.

The vehicle is not limited to the configuration that is able to select at least one of the D range mode, the R range mode, the B range mode, the power mode, the snow mode and the economy mode as the plurality of driving modes. For example, the vehicle may be configured to be able to select at least one of the D range mode, the R range mode, the power mode and the economy mode as the plurality of driving modes.

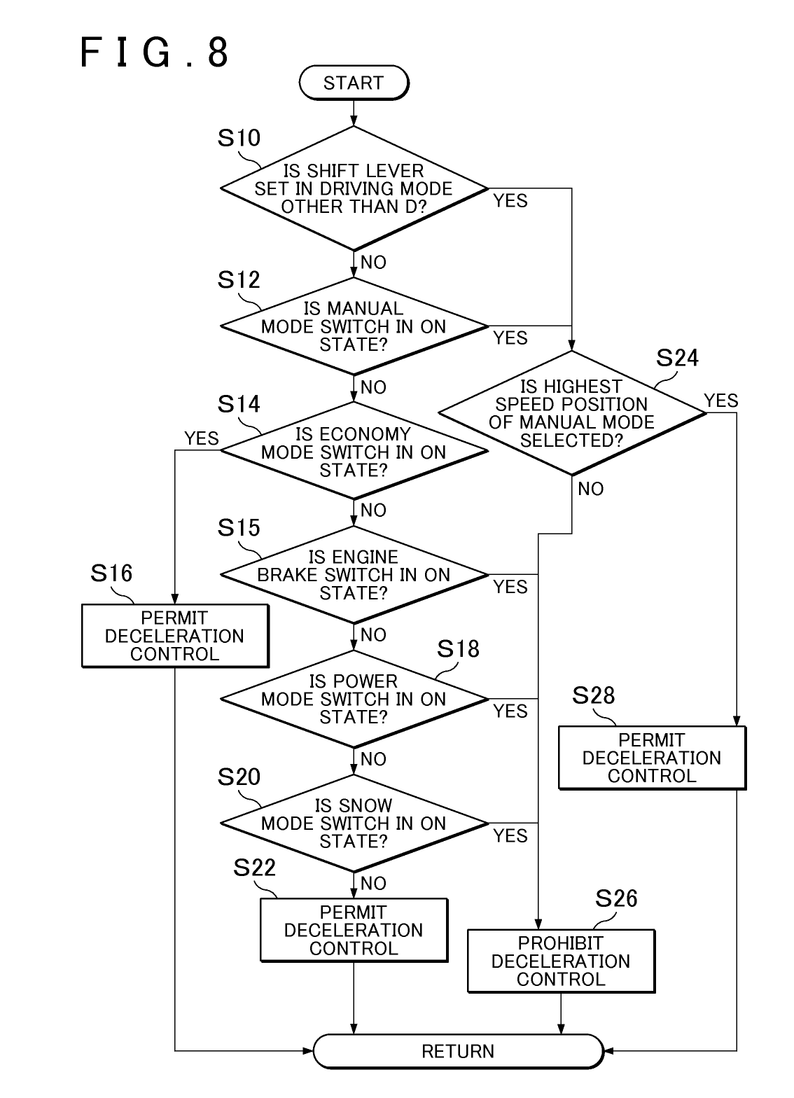

Next, a control system according to a second embodiment of the invention will be described. FIG. 8 is a flowchart that shows a method of determining whether to prohibit or permit deceleration control in the control system according to the second embodiment for the vehicle 10 shown in FIG. 1. The flowchart shown in FIG. 8 differs from the flowchart shown in FIG. 5 in that the process of S12 is added between S10 and S14 and the process of S15 is added between S14 and S18.

Specifically, when negative determination is made in S10, it is determined in S12 whether the manual mode switch 70 is in the on state. When the manual mode switch 70 is not in the on state in S12, it is determined in S14 whether the economy switch 45 is in the on state. When negative determination is made in S14, it is determined in S15 whether the engine brake switch 72 is in the on state. When the engine brake switch 72 is not in the on state, it is determined in S18 whether the power mode switch 43 is in the on state.

When affirmative determination is made in S10 or S12, it is determined in S24 whether the speed position at the highest stage (highest speed position) of the manual mode is selected. When the highest speed position is not selected in S24, deceleration control is prohibited in S26. When the highest speed position is selected, deceleration control is permitted in S28. When the engine brake switch 72 is in the on state in S15 as well, deceleration control is prohibited in S26.

With such a control method, when the highest speed position is selected even in the case where the manual mode is selected, it is determined that an intention to give a higher priority to fuel economy is high, so deceleration control is permitted. In this case, even when deceleration control is permitted, it is possible to achieve deceleration close to a driver's intention, and it is possible to improve fuel economy performance.

In the above-described first and second embodiments, the configuration of the vehicle to which the control system according to the invention is applied is not limited to the configuration shown in FIG. 1, and may be, for example, a vehicle that is not a hybrid vehicle. For example, a simple generator that does not have the function of an electric motor may be used as the generator.

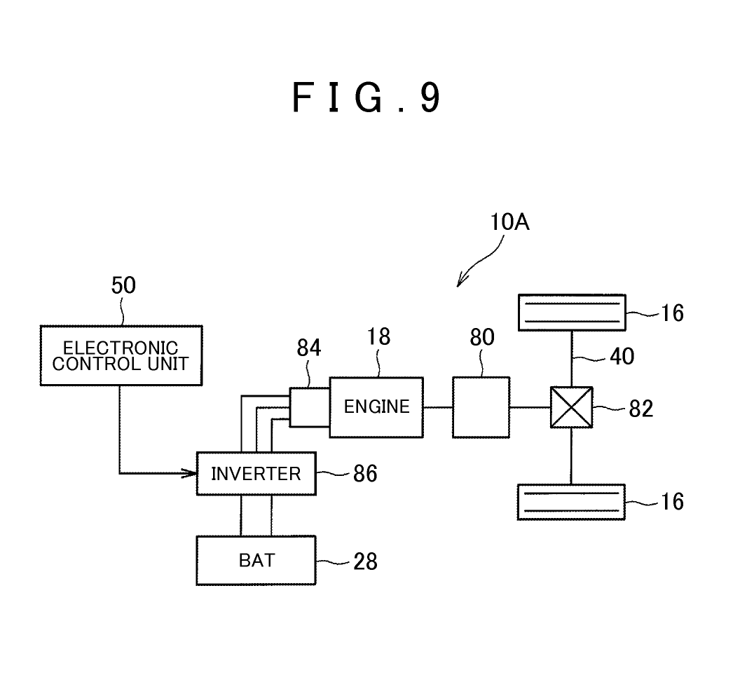

FIG. 9 is a view that shows the configuration of another vehicle 10A to which the control systems according to the first and second embodiments of the invention are applied. The vehicle 10A includes the engine 18, a transmission 80, a differential unit 82 and a generator 84. The vehicle 10A does not include a drive motor. The power of the engine 18 is transmitted to the wheels 16 via the transmission 80, the differential unit 82 and the axles 40. The generator 84 is coupled to the rotary shaft of the engine 18, generates electric power by being driven by the engine 18, and charges the battery 28 with the generated electric power that is supplied via an inverter 86. The generator 84 is a three-phase rotary electric machine similar to the first MG 22 shown in FIG. 1. The electronic control unit 50 controls power generation of the generator 84 by controlling the operation of the inverter 86.

During braking of the vehicle 10A, power from the wheels 16 is transmitted to the generator 84 via the transmission 80 and the engine 18. In this case, the electronic control unit 50 generates regenerative braking force at the wheels 16 by controlling the regenerative torque of the generator 84 through control over the inverter 86. The electronic control unit 50 includes the deceleration control unit 58 and the deceleration control prohibiting unit 60 as in the case of the electronic control unit 50 shown in FIG. 1. The deceleration control unit 58 acquires information including the target stopping position of the vehicle, and executes deceleration control for controlling the deceleration of the vehicle by controlling regenerative power generation of the generator 84 up to the target stopping position. The deceleration control prohibiting unit 60 prohibits deceleration control when the predetermined driving mode is selected by the driver. The predetermined driving mode is similar to that as in the case of the above-described first and second embodiments.

The embodiments of the invention are described above; however, the invention is not limited to those first and second embodiments. Of course, the invention may be implemented in various forms without departing from the scope of the invention. For example, the control system 12 that uses the navigation system 32 is described in the configuration shown in FIG. 1. Instead, a control system may have a configuration that the navigation system is omitted and a receiving unit that receives infrastructure information, including traffic light positions and red signal information about traffic lights, is provided instead of the navigation system. When the electronic control unit 50 acquires red signal information about the traffic light located forward of the vehicle from the infrastructure information, the electronic control unit 50 is able to acquire a position that is estimated to be just before the above traffic light as the target stopping position through calculation, and execute deceleration control by using a distance to the target stopping position and a detected value of the vehicle speed.

The electronic control unit 50 may be configured to have the function of prompting the driver to carry out large deceleration after the deceleration setting point td with the use of the display unit 35 at the time of executing deceleration control. The notification unit that notifies the driver of the execution status of deceleration control is not limited to the display unit 35, and may be a voice output unit that notifies the driver of the execution status of deceleration control by voice.

While the invention has been described with reference to example embodiments thereof, it is to be understood that the invention is not limited to the described example embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A control system for a vehicle, the control system comprising:
a rotary electric machine configured to generate regenerative braking force at a wheel by generating electric power with the use of power from the wheel during braking of the vehicle; and
an electronic control unit configured to:
(a) acquire information including a target stopping position of the vehicle,
(b) execute deceleration control for controlling a deceleration of the vehicle by controlling regenerative power generation up to the target stopping position, and
(c) prohibit the deceleration control when a predetermined driving mode set in advance in response to input through driver's operation is selected from among a plurality of driving modes having specific acceleration/deceleration characteristics.

2. The control system according to claim 1, wherein
the electronic control unit is configured to prohibit the deceleration control when a driving mode is selected as the predetermined driving mode, and
in the driving mode, deceleration characteristics of the vehicle changes in response to input through the driver's operation and does not give a higher priority to fuel economy.

3. The control system according to claim 2, wherein
the electronic control unit is configured to prohibit the deceleration control when a driving mode is selected as the predetermined driving mode, the driving mode is determined when a shift operating unit is operated to a position other than a normal forward running position.

4. The control system according to claim 2, wherein
the electronic control unit is configured to prohibit the deceleration control when a power mode is selected as the predetermined driving mode, and
in the power mode, an acceleration and a deceleration is larger at the same vehicle speed than those during normal forward running.

5. The control system according to claim 2, wherein
the electronic control unit is configured to prohibit the deceleration control when a snow mode is selected as the predetermined driving mode, and
in the snow mode, snow road running performance is raised as compared to that during normal forward running.

6. The control system according to claim 2, wherein
the electronic control unit is configured to prohibit the deceleration control when a manual shift mode is selected as the predetermined driving mode, and
in the manual shift mode, a relationship between an operating state of one of an engine and the rotary electric machine and a vehicle speed is allowed to be changed in multiple stages.

7. The control system according to claim 2, wherein
the electronic control unit is configured to prohibit the deceleration control when a braking force increasing mode is selected as the predetermined driving mode, and
in the braking force increasing mode, one of engine brake during decelerating and a braking torque corresponding to the engine brake is increased.

8. The control system according to claim 2, wherein
the electronic control unit is configured to prohibit the deceleration control when a manual shift mode is selected as the predetermined driving mode,
in the manual shift mode, a relationship between an operating state of one of an engine and the rotary electric machine and a vehicle speed is allowed to be changed in multiple stages,
the electronic control unit is configured to permit the deceleration control when the manual shift mode is not selected as the predetermined driving mode and an economy mode is selected, and
in the economy mode, fuel economy performance is raised as compared to that during normal forward running.

9. The control system according to claim 1, wherein
the electronic control unit is configured to prohibit the deceleration control when a manual shift mode is selected as the predetermined driving mode and when a stage other than a highest stage,
in the manual shift mode, a relationship between an operating state of one of an engine and the rotary electric machine and a vehicle speed is allowed to be changed in multiple stages,
in the highest stage, a maximum vehicle speed is the highest among the multiple stages is selected, and
the electronic control unit is configured to permit the deceleration control when the manual shift mode is selected as the predetermined driving mode and the highest stage is selected.

10. The control system according to claim 1, further comprising:
a notification unit configured to provide notification that an execution status of the deceleration control, wherein
the electronic control unit is configured to provide notification about the execution status of the deceleration control with the use of the notification unit.

11. The control system according to claim 10, wherein
the notification unit includes a display unit configured to indicate the execution status of the deceleration control.

12. The control system according to claim 10, wherein
the notification unit includes a voice output unit configured to provide notification about the execution status of the deceleration control by voice.
